(19) United States
(12) Patent Application Publication
(10) Pub. No.: US 2005/0175400 A1
(43) Pub. Date: Aug. 11, 2005

(54) Add-on part for a vehicle

(76) Inventors: Thomas Behr, Elchingen (DE); Konrad Eipper, Rottenburg (DE); Wolfgang Fussnegger, Tuebingen (DE); Arndt Gerick, Ulm (DE); Daniel Minnich, Ulm (DE); Matthias Scheffzuek, Tuebingen (DE)

Correspondence Address: PENDORF & CUTLIFF, 5111 MEMORIAL HIGHWAY, TAMPA, FL, 33634-7356, US

(21) Appl. No.: 11/017,353

(22) Filed: Dec. 20, 2004

(30) Foreign Application Priority Data
Dec. 19, 2003 (DE) 103 59 785.9-21

(51) Int. Cl. F16B 11/00; B25G 3/34

(52) U.S. Cl. 403/267

(57) ABSTRACT

The invention pertains to an add-on part for a vehicle formed as a cast part 1, which is connectable to a vehicle body of the vehicle and for this purpose has a connection part 2 accommodated in cavity 3, in which the joining element or connection part 2 is cast into the cast part during production of the cast part 1.

### BACKGROUND OF THE INVENTION

1. Field of the Invention

The invention concerns an add-on part (attached part, mounted part) for a vehicle consisting of a cast part suitable for connection to the vehicle body of the vehicle, especially made of steel or light metals, wherein at least one joining element or connecting part is cast into the cast part.

2. Background of the Invention

A cast vehicle component is already known (EP 0 497 209), produced in a die-casting method and consisting of a light metal alloy. The add-on part is used for connection to other vehicle parts and consists of a structure produced in a vacuum die-casting method, for example, from a steel sheet, onto which, after it is produced, a sheet steel structure is cast on or cast in. This method is not suitable for thin-walled cast parts.

### SUMMARY OF THE INVENTION

The underlying task of the invention is to design the add-on part and arrange it so that the cast part and the joining element or connection part are integrated firmly, even in a thin-walled cast part, so that it can be exposed to high loads.

This task is solved according to the invention in that during production of the cast part the joining element or connection part has perforations and/or a structured surface and is cast roughly centrally in the thin-walled cast part. Because of this, the production method can be significantly simplified, since it can get by with fewer working steps. In addition, a perfect, firm joint between the parts is created by this method.

For this purpose it is advantageous for the joining element or connection part to protrude from the cast part and be connectable with the body part. A simple, cost-effective, easy-to-manipulate connection that can be produced with very few working steps is created for cast and body parts in vehicle construction thereby.

A further possibility, according to a further development of the invention, is to join the joining element or connection part by welding, especially spot-welding or riveting or penetration joining, or to provide a form fitting connection to the body part and to provide the surface of the joining element or connection part with friction resistance elements or embossings in the form of barbs.

It is also advantageous that the joining element or connection part is formed as a molded sheet part having openings in the front edge region that can easily enter into a form-fitting or shape-mated connection between the cast part and the body part.

Finally, according to a preferred embodiment of the invention, it is proposed that the joining element or connection part be designed as a stiffening or reinforcing element. The stiffening elements can be inserted into the mold during the casting process so that they can be used for reinforcement.

It is of special significance to the present invention that the joining element or connection part has roughly the same thickness as the body part being connected.

It is also possible that the joining element or connection part has embossings or resistance elements on its flange so that a connection between the cast part and the body part can be produced in simple and rapid fashion.

### BRIEF DESCRIPTION OF THE DRAWING

Additional advantages and details of the invention are explained in the patent claims and in the description and shown in the figures. In the figures:

FIG. 1 shows a first illustrative embodiment of an add-on part for a vehicle consisting of a cast-in part connectable to the vehicle body of the vehicle in which the cast connection part is perforated;

FIG. 2 shows another illustrative embodiment of an add-on part for a vehicle in which the cast-in connection part is corrugated;

FIG. 3 shows a third illustrative embodiment of an add-on part for a vehicle in which the cast-in connection part is provided with barbs;

FIG. 4 shows a fourth illustrative embodiment of an add-on part for a vehicle in which the part protruding from the opening has form-fitting elements;

FIG. 5 shows a fifth illustrative embodiment of an add-on part for a vehicle in which the part protruding from the opening has plug-in connection elements.

### DETAILED DESCRIPTION OF THE INVENTION

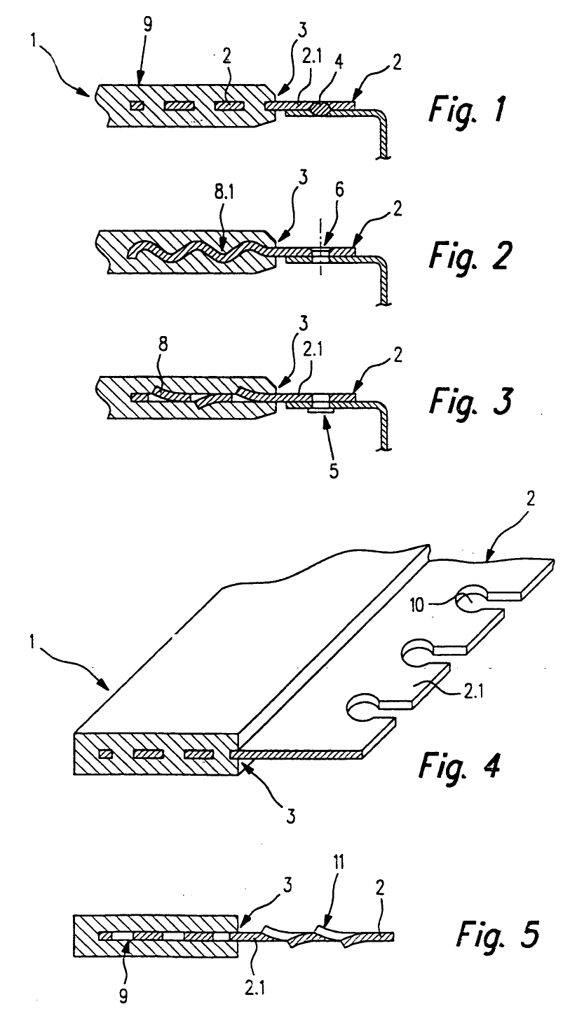

An add-on part denoted 1 in FIG. 1, which in the illustrative embodiment is a cast part, can be connected by means of a joining element or connection part 2 to a body part of a vehicle—not shown in the drawing. The cast part 1 is designed so that it can be connected, among other things, to very thin sheets. For this purpose the cast part 1 is provided with at least one cavity 3 that serves to accommodate the joining element or connection part 2, which protrudes slightly from the opening according to the illustrative embodiment and therefore forms a connection flange 2.1 that can be connected in different ways to a body part.

The connection part 2 is cast into the cavity 3 of the cast part 1 during production of cast part 1 (composite casting) and a simple production method is therefore devised.

In the illustrative embodiments according to FIGS. 1, 4 and 5 the joining element or connection part 2 can be provided with perforations 9 so that during the casting process for production of the cast part 1, a fixed connection between the cast part 1 and the joining element or connection part 2 is created, since the cast material can penetrate during the casting process into the perforations 9 of the joining element or connection part 2. According to FIG. 1, the flange 2.1 can be connected to a body part via a spot-welding joint 4. Flange 2.1 protrudes slightly from cavity 3 for this purpose.

However, connection can also occur by other common joining techniques, for example, gluing.

In the illustrative embodiment according to FIG. 2, the joining element or connection part 2 is corrugated in the region of cavity 3 and according to FIG. 3 is provided with embossings 8.1 or friction resistance elements such as barbs 8 so that after the casting process a fixed joint is also created between the joining element or connection part 2 and the body part.

According to FIG. 4, the flange 2.1 in the front edge region can have connection devices in the form of openings 10 so that they can enter into a shape-mated connection with a body part.

According to FIG. 5, the flange 2.1 can have embossings or friction resistance elements 11 in the front edge region so that the flange 2.1 can also produce a connection to a body part as a plug connection. In addition, the joining element or connection part 2 or the flange 2.1 can have roughly the same thickness as the body part being connected.

Before the casting process, the components and connection elements or connection parts 2 are inserted into the casting mold and then cast. The connection elements or connection parts 2 can be designed so that the connection elements or connection parts 2 are roughly equivalent in material thickness to the adjacent component or cast part 1.

The connection elements or connection parts 2 can be inserted into the casting mold before the casting process so that they can also be used as a reinforcement.

1. An add-on part for a vehicle consisting of
a thin walled cast part (1) connectable to the vehicle body of the vehicle,
wherein at least a part of least one joining element or connection part (2) is cast into the cast part (1) for incorporation thereof,
wherein the joining element or connection part (2) has perforations and/or a structured surface and
wherein during production of the cast part the at least one joining element or connection part (2) is cast into the cast part (1) approximately centrally.

2. A device according to claim 1,
wherein the joining element or connection part (2) protrudes from the cast part (1) and is fixedly connectable to the body part.

3. A device according to claim 1,
wherein the joining element or connection part (2) is connectable to the body part via a welding joint, especially a spot-welding joint (4), or by means of a rivet joint (5) or penetration joint (6) or form-fitting joint (7).

4. A device according to claim 1,
wherein the surface of the joining element or connection part (2) has friction resistance elements (8) or embossings (8.1) formed as barbs.

5. A device according to claim 1,
wherein the joining element or connection part (2) is formed as a sheet-molded article having openings (10) in the front edge region that can enter into a shape-mated connection with a body part.

6. A device according to claim 1,
wherein the joining element or connection part (2) is a stiffening or reinforcing element.

7. A device according to claim 1
wherein the joining element or connection part (2) has roughly the same thickness as the body part to which a connection is beinf formed.

8. A device according to claim 1
wherein the joining element or connection part (2) has embossings 8.1 or resistance elements (11) on its flange (2.1).
